(19) United States
(12) Patent Application Publication
(10) Pub. No.: US 2006/0223447 A1
(43) Pub. Date: Oct. 5, 2006

(54) Adaptive down bias to power changes for controlling random walk

(76) Inventors: Ali Masoomzadeh-Fard, Marlboro, NJ (US); Martin H. Meyers, Montclair, NJ (US); Walid E. Nabhane, Bedminister, NJ (US); Richard J. Pauls, Lafayette, NJ (US); Alexandro Salvarani, Edison, NJ (US); Carl F. Weaver, Morris Plains, NJ (US)

Correspondence Address: CARLSON, GASKEY & OLDS, P.C., 400 W MAPLE RD, SUITE 350, BIRMINGHAM, MI, 48009, US

(21) Appl. No.: 11/096,200

(22) Filed: Mar. 31, 2005

(51) Int. Cl. H04B 7/00; H04Q 7/20

(52) U.S. Cl. 455/69; 455/522

(57) ABSTRACT

A wireless communication network (20) utilizes a down bias to minimize or eliminate random walk when controlling a transmit power between a base station (38) and a mobile station (40). In a disclosed example, a link quality monitoring module (54) determines the quality of a link between the mobile station (40) and the base station (38). A power control module (52) applies a down bias, which is dependent on the determined link quality, to a transmit power correction for minimizing random walk. In a disclosed example, the down bias varies linearly and inversely proportionally to the quality of the link between the mobile station and the base station.

### FIELD OF THE INVENTION

This invention generally relates to telecommunications. More particularly, this invention relates to wireless communication systems.

### DESCRIPTION OF THE RELATED ART

Wireless communication systems typically rely upon communications between a mobile station such as a cell phone or notebook computer and a base station. The wireless network communicates with the base station using known techniques. Power control in wireless communication systems such as code division multiple access (CDMA) systems is necessary for controlling interference and maintaining quality service. Power control techniques are used to reduce interference. Excess power used in transmissions tends to increase interference.

The link between the base station and the mobile station may vary with different channel conditions and different geographic relationships between the mobile station and the base station, for example. As the quality of the link varies, known techniques are used to attempt to maintain a desired level of service.

For example, when a mobile station detects a signal to interference ratio that is outside of a desired range, the mobile station issues a power control command (TPC) to the base station with which the mobile station is communicating. If a mobile station detects a signal to noise ratio that is above a threshold, the TPC corresponds to a request to decrease the transmit power. If the mobile station detects a signal to noise ratio that is less than a threshold, the TPC command corresponds to a request to increase the transmit power.

It is possible for TPC transmissions from a mobile station to be unreliable. This is especially true when the quality of the link between the mobile station and the base station is degrading. Unreliable TPC's may cause undesirable responses from one or more base stations, which results in undesirably high or undesirably low power levels used for transmissions from such a base station. Such undesirable variation from a desired power control level is sometimes referred to as random walk. It is important to limit or eliminate random walk. This is especially true during soft handoff procedures where a mobile station is communicating with more than one base station, simultaneously.

If the link quality is poor for one of the base stations communicating with the mobile station, the TPC error rate during soft handoff can be relatively high. The transmit power on that link may go up or down in a random fashion (i.e., random walk). This may continue for a weak or low quality link during the entire portion of a handoff procedure during which the system decides to remove that link from the mobile's active set until the time that the link is actually removed.

One problem experienced when random walk occurs is that the transmit power of a weak link can increase randomly. As a result, the weak link becomes dominant in the downlink direction even though other links have better quality. High transmit power on the weak link can, therefore, cause the mobile station to respond with TPC's requesting a decrease in power. The base stations having better quality or stronger links typically respond to such a TPC because of the reliable link in the uplink direction. The weaker link base station, however, may not decrease its power because of the poor quality communication along that link. It is possible, therefore, for the transmit power of weak and strong links to move in different directions. Under these circumstances, the unnecessarily high transmit power on the weak link causes capacity loss and performance degradation.

There have been proposals to resolve the problem of random walk in downlink transmissions in CDMA systems. One approach is known as power balancing that includes an attempt to synchronize the transmit power of all base stations in a mobile station's active set. Such power balancing is applied to the transmit powers along with inner loop power control for each base station.

Another proposal has been to down bias the transmit power of all base stations within a mobile station's active set. One proposal includes minimum constraints to prevent the transmit power from going down too much during random walk.

One drawback of such proposals is that they affect the operation of inner loop power control for all base stations within an active set even if the radio links associated with those base stations have good quality and there is not a significant amount of random walk at each of the base stations. The amount of correction used is independent of the quality of the radio links between the mobile station and the base stations involved in a soft handoff procedure. In other words, previous proposals for addressing random walk are essentially blind to the actual random walk conditions and are not capable of individualizing random walk control for each base station.

### SUMMARY OF THE INVENTION

The present invention provides an improved solution to the problems mentioned above.

An exemplary disclosed method of communicating includes applying a down bias, which may be based upon a quality of a link between a mobile station and a base station, to a transmit power correction for that link.

One example includes determining the quality of the link based on at least one quality metric. In one example, the quality metric may be based upon at least one signal received from the mobile station. The down bias may then be determined dependent on the determined quality of the link.

One example includes using a first down bias if the quality of the link is at a first level and using a second, lower down bias if the quality of the link is at a second, higher level. Varying the down bias responsive to the level of the quality of the link between the mobile station and the base station provides for better power control management across an active set during soft handoff procedures, for example.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system that utilizes a power control strategy designed according to an embodiment of this invention.

FIG. 2 is a flow chart diagram summarizing one example approach.

### DETAILED DESCRIPTION

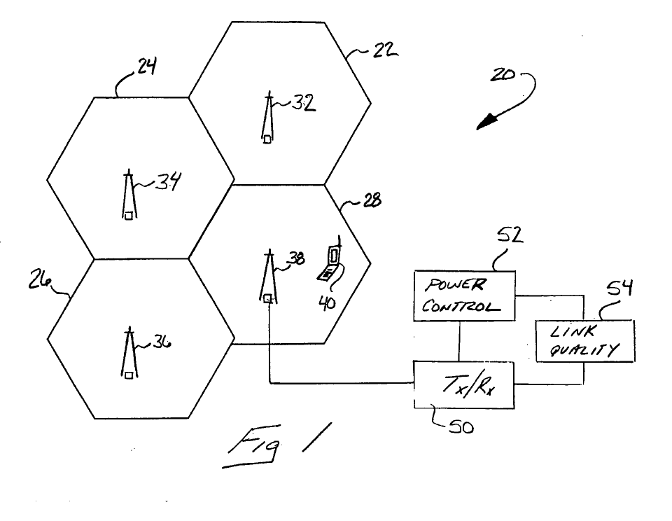

FIG. 1 schematically shows selected portions of a wireless communication network 20. A plurality of cells 22, 24, 26 and 28 are served by base stations 32, 34, 36 and 38, respectively. The base stations 32-38 communicate with a radio network controller and other portions of a wireless communication network in a known manner.

A mobile station 40 is schematically shown within the geographic region or area of coverage of the cell 28. Communications between the mobile station 40 and another device using the wireless communication network occurs over an existing link between the base station 38 and the mobile station 40. Under some circumstances, the mobile station 40 will simultaneously communicate with one or more of the base stations 32, 34 or 36 and the base station 38. Under such circumstances, the mobile station 40 has an active set that includes more than one of the illustrated base stations. This may occur, for example, during a soft handoff procedure.

There will be circumstances when the link or leg between the mobile station 40 and one or more of the base stations 32-38 has good quality and there will be other circumstances where the link has poor quality. The mobile station 40 in this example uses known techniques for issuing power control commands (TPCs) requesting transmit power to be increased or decreased based upon a determination made at the mobile station 40. In one example, the mobile station uses a signal to noise ratio associated with a pilot signal from each base station in a known manner for generating the power control command (TPC).

Each base station in the illustrated example includes a controller having a transceiver 50 that receives signals from the mobile station 40 and transmits signals to the mobile station 40. A power control module 52 controls the power with which the transceiver 50 transmits to the mobile station 40. The power control module 52 is part of the inner loop power control for the base station. In addition to controlling the power of transmissions based upon a system design or standard parameters imposed by a standards body, for example, the power control module 52 manages the transmit power in the downlink (i.e., from the base station to the mobile station) based upon a TPC from the mobile station 40 and the quality of the link with the mobile station.

The illustrated example includes a link quality monitoring module 54 that utilizes one or more quality metrics to determine a level of quality of the link between the mobile station 40 and each base station within the active set for the mobile station. In one example, the quality metric comprises a signal to noise ratio associated with a pilot signal from the mobile station 40. The base station 38 estimates the detected signal to noise ratio in a known manner. The link quality monitoring module 54 utilizes that estimation and determines a level of quality of the link.

The power control module 52 utilizes the information from the link quality monitoring module 54 and responsively controls the transmit power in the downlink based upon the link quality and the received TPC. The power control module 52 applies a transmit power correction factor to a current transmit power to increase or decrease the transmit power, depending on the TPC.

In one example, the power control module 52 applies a down bias to the transmit power correction before it is implemented. The down bias is intended to dampen the effects of changes in the transmit power made responsive to TPCs from the mobile station 40 that may result in random walk. By dampening such effects, random walk is minimized or eliminated.

By utilizing the quality of the link between the mobile station and the base stations within its active set, the disclosed example adaptively controls the occurrence of random walk. Moreover, the illustrated example can control transmit power corrections or adjustments for each individual base station in a manner corresponding to the quality of the link between a mobile station and that base station.

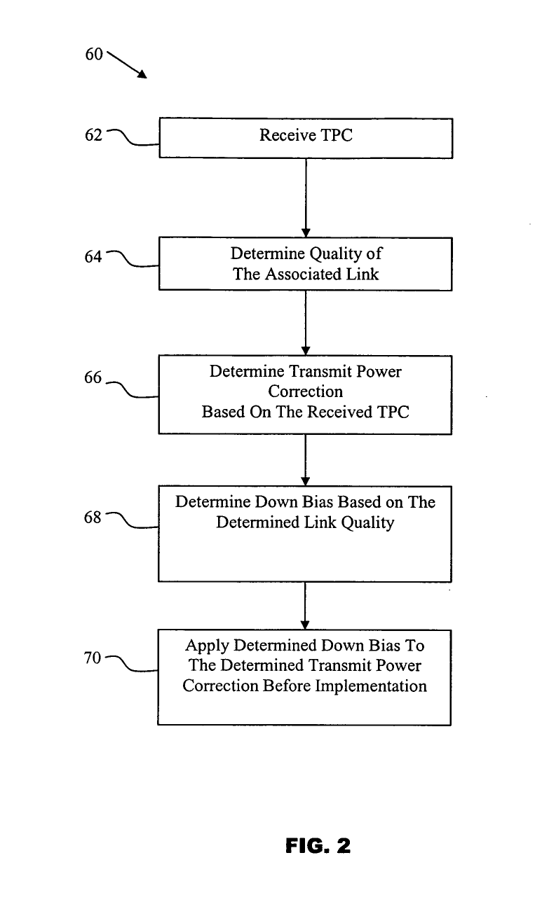

FIG. 2 includes a flow chart 60 summarizing an exemplary approach. A TPC is received at 62. The quality of the associated link is determined at 64. The transmit power correction is at least initially determined at 66 based on the TPC. A down bias is determined based at 68 based upon the determined quality of the link. Finally, the down bias is applied to the transmit power correction at 70 before the transmit power correction is implemented.

In one example, the down bias is essentially inversely proportional to the quality of the link. Higher quality links typically have more reliable TPC signal transmissions. For higher quality links, the amount of down bias can be lower because the TPCs from the mobile station 40 are generally reliable. For lower quality links, there may be increased errors in a TPC. Therefore, the illustrated example utilizes more of a down bias for lower quality links to minimize the effects of erroneous power control commands, for example. In other words, the illustrated example utilizes a quality metric indicative of the reliability of received power control commands for adaptively controlling the transmit power on a corresponding link.

One example includes selecting a link quality range that has a maximum threshold and a minimum threshold. The link quality monitoring module 54 compares a determined link quality level to the link quality range. If the determined quality level is below the minimum threshold of the link quality range, a maximum down bias ratio is applied by the power control module 52 to prevent transmit power from going up unnecessarily, which minimizes or eliminates random walk. If the determined link quality is above the maximum threshold of the link quality range, the power control module 52 applies a minimum down bias ratio because the good quality link provides a reliable indication of a need to adjust the transmit power (i.e., a reliable TPC). In one example, the minimum down bias ratio is zero. In other words, the link quality may be good enough that the down bias ratio applied for such a link has no effect on the transmit power correction.

In one example, whenever the link quality monitoring module 54 determines that the link quality is within the link quality range, a down bias ratio is applied that corresponds to the determined quality metric or link quality. In one example, the down bias ratio varies essentially linearly with (and inversely proportional to) the link quality. That is, as the link quality decreases, the down bias ratio linearly increases. At the same time, as the determined link quality increases, the down bias ratio decreases in a linear manner.

Given this description, those skilled in the art will be able to determine appropriate down bias values to apply, given a determined link quality or quality metric value.

The illustrated example shows a power control module 52 and link quality monitoring module 54 associated with one of the base stations. In some examples each base station will have a dedicated power control module 52 and link quality monitoring module 54. In other examples, such components are implemented within appropriate portions of the wireless network such that the appropriate power control for each base station can be carried out according to the above description.

It should be noted that the power control module 52 and the link quality monitoring module 54 are schematically shown for discussion purposes. Either or both of these modules may be implemented using software, hardware, firmware or a combination of them. Those skilled in the art who have the benefit of this description will realize how best to arrange a base station or a wireless network to achieve the results provided by the disclosed example for purposes of meeting the needs of their particular situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating between at least one base station and at least one mobile station, comprising:
applying a down bias, based upon a quality of a link between the mobile station and the base station, to a transmit power correction for the link.

2. The method of claim 1, comprising determining the quality of the link based on at least one quality metric.

3. The method of claim 2, comprising determining the quality metric from at least one signal received from the mobile station.

4. The method of claim 2, comprising determining the down bias dependent on the determined quality of the link.

5. The method of claim 1, comprising applying a first down bias if the quality of the link is at a first level and applying a second, lower down bias if the quality of the link is at a second, higher level.

6. The method of claim 5, comprising varying the down bias linearly relative to the quality of the link.

7. The method of claim 6, comprising varying the down bias inversely proportionally to the quality of the link.

8. The method of claim 5, wherein the first level is below a first selected quality threshold and the first down bias is a maximum down bias and the second, higher level is above a second, higher selected quality threshold and the second down bias has no effect on the transmit power correction.

9. The method of claim 1, comprising
receiving a power control command from the mobile station;
determining the quality of the link;
determining the down bias corresponding to the quality of the link; and
applying the down bias to the transmit power correction that is responsive to the received power control command.

10. The method of claim 1, comprising:
selecting a link quality range;
applying a maximum down bias if the quality of the link is below the quality range;
applying a minimum down bias if the quality of the link is above the quality range; and
applying a down bias that varies according to the quality of the link if the quality of the link is within the quality range.
